(19) United States
(12) Patent Application Publication
(10) Pub. No.: US 2013/0210251 A1
(43) Pub. Date: Aug. 15, 2013

(54) ELECTRICAL CONNECTOR WITH MULTIPLE DETECT MECHANISM THEREOF

(71) Applicants: TERRANCE F. LITTLE, Fullerton, CA (US); AN-JEN YANG, Irvine, CA (US); STEPHEN SEDIO, Valley Center, CA (US)

(72) Inventors: TERRANCE F. LITTLE, Fullerton, CA (US); AN-JEN YANG, Irvine, CA (US); STEPHEN SEDIO, Valley Center, CA (US)

(21) Appl. No.: 13/757,738

(22) Filed: Feb. 2, 2013

Related U.S. Application Data
(60) Provisional application No. 61/598,929, filed on Feb. 15, 2012.

(51) Int. Cl. H01R 13/703

(52) U.S. Cl. CPC H01R 13/7036
USPC 439/188

(57) ABSTRACT

A receptacle connector includes an insulative housing defining a base with a mating tongue. A plurality of contacts are disposed in the housing with contacting sections exposed on the mating tongue. A metallic shell is assembled to the housing and defines a mating cavity into which the mating tongue extends. A plurality of spring tangs are formed on the shell and extend into the mating cavity for retainable abutment against the inserted plug. A dome switch is located outside of the shell and intimately confronts the corresponding spring tang so as to be activated when the corresponding spring tang is outwardly deflected by the inserted plug. An addition detect pin is electrically connected to the dome switch when the dome switch is activated to verify whether the plug is inserted in the mating cavity or to identify whether a high power is required.

### CROSS REFERENCE TO RELATED APPLICATIONS

This application claims the benefit of, and priority to, U.S. Provisional Patent Application No. 61/598,929, filed Feb. 15, 2012, the contents of which are incorporated entirely herein by reference.

### BACKGROUND OF THE INVENTION

1. Field of the Invention

The present invention relates to an electrical receptacle connector, and more particularly to the USB (Universal Serial Bus) connector equipped with detect pins associated with an activation device thereof. This is a continuation of the provision application 61/593,826 filed on Feb. 1, 2012.

2. Description of Related Art

The USB connector as an interface, is popularly used in the industry. Even if the USB connector carries power constantly, in some situation a relatively large power is required. Therefore, it is expected to have the receptacle connector, which is mounted upon the mother board, equipped with detect pins to identify whether the mated plug requires the relatively high power. On the other hand, the additional detect pins used in the conventional USB receptacle connector essentially extend into the mating cavity for activation by the inserted plug, and in some cases the corresponding metallic shell, which confines/surrounds the mating cavity, may be required to be modified for corresponding to such additional detect pins. Such modification may potentially jeopardize the electrical and mechanical performance of the metallic shell and induce improper shorting.

Hence, a USB receptacle connector equipped with the detect pins optionally without sacrificing the original mechanical and electrical performance is desired.

### SUMMARY OF THE INVENTION

Accordingly, an object of the present invention is to 1. An electrical connector for use with a plug comprises: an insulative housing, plurality of contacts, a printed circuit board and a plurality of detect pins. The insulative housing is enclosed in a metallic shell to commonly define a mating port, the contacts are disposed in the housing with contacting sections exposed in the mating port. The printed circuit board is assembled to the bottom of the insulaitve housing and formed with at least a front dome switch and a rear switch, the front dome switch is moveable in a direction perpendicular to a front-to-back direction and is adapted for being activated by the plug received in the mating port; the rear switch is located at the rear of the mating port and adapted for being activated by the plug received in the mating port, and the rear switch is a cantilevered contact. And the detect pins are electrically connected to the dome switch and the rear switch; wherein tails of the said contact and that of the detect pins are both arranged in a rear side of the housing.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an electrical single port USB connector in accordance with a first embodiment of the present invention;

FIG. 2 is an upside-down perspective view showing the connector of FIG. 1 without the printed circuit board and the associated flexible member;

FIG. 3 is an upside-down perspective view showing the connector of FIG. 1 with the printed circuit board and the associated flexible member;

FIG. 4 is an enlarged perspective view to show the printed circuit board with the dome switch thereon;

FIG. 5 is an enlarged perspective view to show that the printed circuit board is associated with the flexible member; and

FIG. 6 is an enlarged perspective view to show the flexible member.

FIG. 7A and FIG. 7B are two different perspective views of a connector by removing the printed circuit board and the flexible member in accordance with a second embodiment of the present invention.

FIG. 8 is a perspective view of the printed circuit board and the flexible member of the connector of FIG. 7.

FIG. 9 is a perspective view of the connector of FIG. 7 with the printed circuit board and the flexible member thereof.

FIG. 10 is a perspective view of the dual-port connector in accordance with a third embodiment of the invention.

FIG. 11 is a partial bottom view of the connector of FIG. 10 to show the rear portion thereof.

FIG. 12 is a diagram to show how the insertion detect contact and the PD detect contact work with the inserted plug.

FIG. 13 is a perspective view of portion of the connector of FIG. 10 to show how the upper printed circuit board is assembled to thereto.

FIG. 14 is a perspective view of portions of the connector of FIG. 10 to show how the side PD pin insert mold assembly assembled to thereto.

FIG. 15 is another partial perspective view of portions of the connector of FIG. 10 to show the side PD pin insert mold assembly.

FIG. 16 is a perspective view of portions of the connector of FIG. 10 to show how the lower printed circuit board is assembled to thereto.

FIG. 17 is a perspective view of portions of the connector of FIG. 10 to show the lower printed circuit board is assembled to thereto.

FIG. 18 is a perspective view of portions of the connector of FIG. 10 to show the center shell is assembled to the thereto.

FIG. 19 is a perspective view of portions of the connector of FIG. 10 to show the main shell is assembled thereto.

FIG. 20 is a perspective view of the complete connector of FIG. 10 to show the rear shell is assembled thereto.

### DETAILED DESCRIPTION OF THE PREFERRED EMBODIMENT

Reference will now be made in detail to the first preferred embodiment of the present invention.

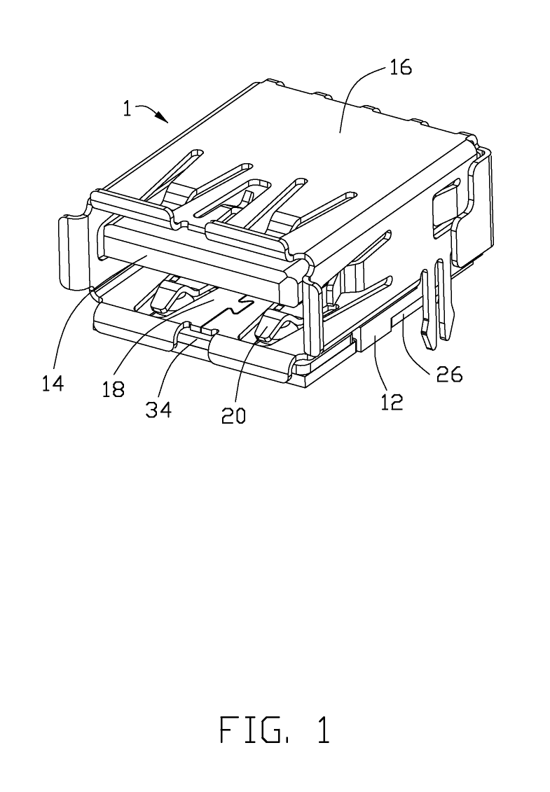

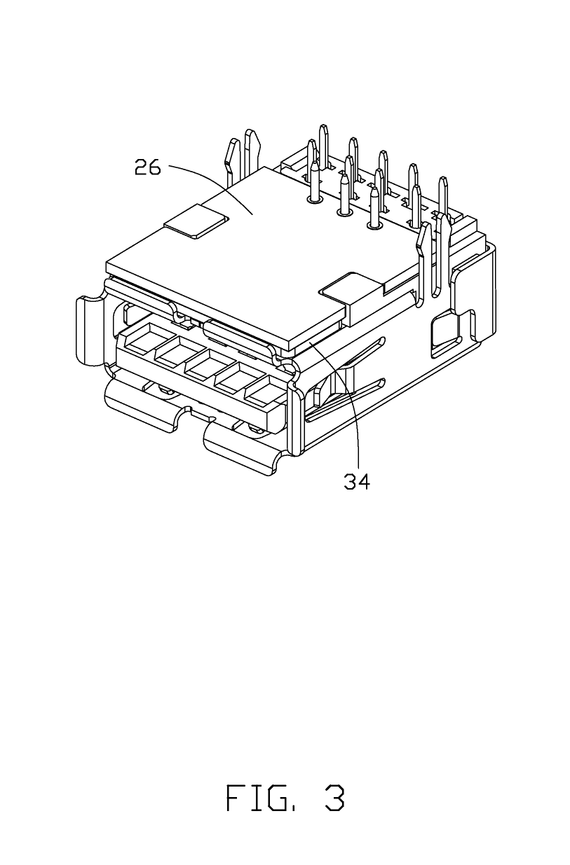

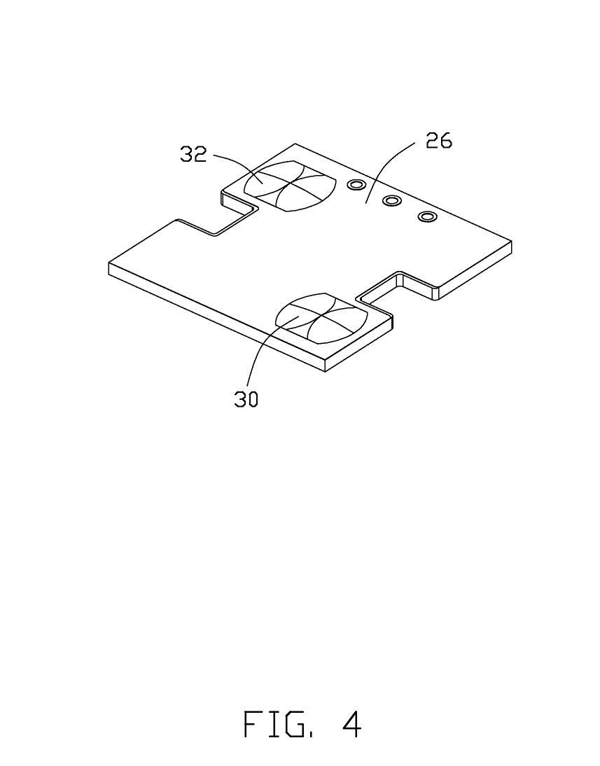

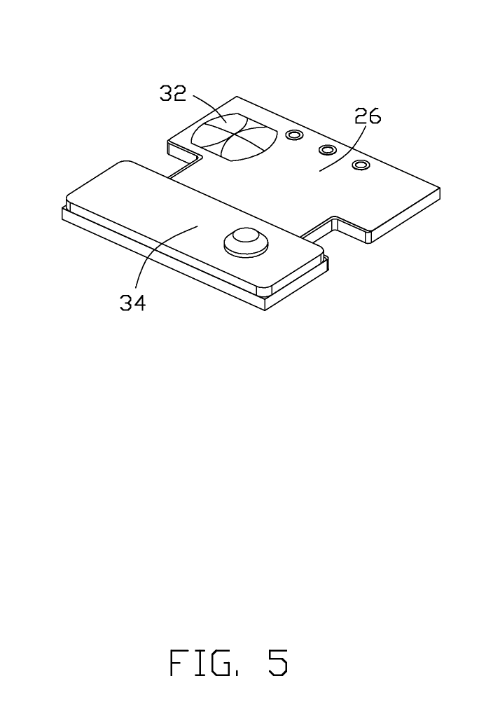

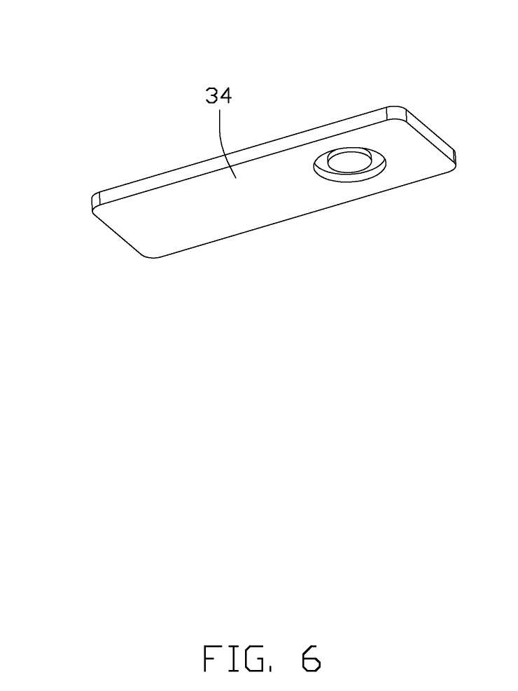

Referring to FIGS. 1-6, an electrical receptacle connector 1, which is essentially a so-called USB 3.0 connector for use with a plug (not shown) and mounting to a mother board (not shown), includes an insulative housing 12 with a forwardly extending mating tongue 14 thereof, and a metallic shell 16 is assembled to the housing 12 to define a mating cavity 18 into which the mating tongue extends. A plurality of spring tangs 20 unitarily extend from the shell into the mating cavity 18. Four deflectable contacts 22 and five stationary contacts 24 are disposed in the housing 12 with contacting sections exposed upon the mating tongue 14 to compliance with USB 3.0 standard.

A printed circuit board 26 is intimately located under the shell 16 and the associated housing 12 with a front dome switch 30, for plug insertion detection, vertically aligned with a portion of the corresponding spring tang 20 around a front portion of the mating cavity 18, and a rear dome switch 32, for high power delivery detection, vertically aligned with a portion of another corresponding spring tang 20 (not shown) around a rear portion of the mating cavity 18.

A flexible member 34 covers the corresponding dome switch 30, 32 and directly confront the corresponding spring tang 20. The flexible member 34 is formed with a button upwardly protruding as observed from a top side but recessed upwardly as observed from a bottom side. The button is disposed above the insertion detect dome switch 30 so as to activate the insertion detect dome switch 30 when the button is pressed downwardly. Three tubes not (labeled) are formed on a rear edge of the printed circuit board 26 and electrically connect with the dome switches 30, 32 by conductive traces within the printed circuit board. A plurality of additional detect pins 36 are retained to the housing 12 and extend through the printed circuit board 26 for being mounted to the mother board and are electrically connected to the corresponding dome switch 30, 32 via conductive traces (not shown) of the printed circuit board 26. Alternatively, the additional detect pins 36 may directly retained to the printed circuit board 26.

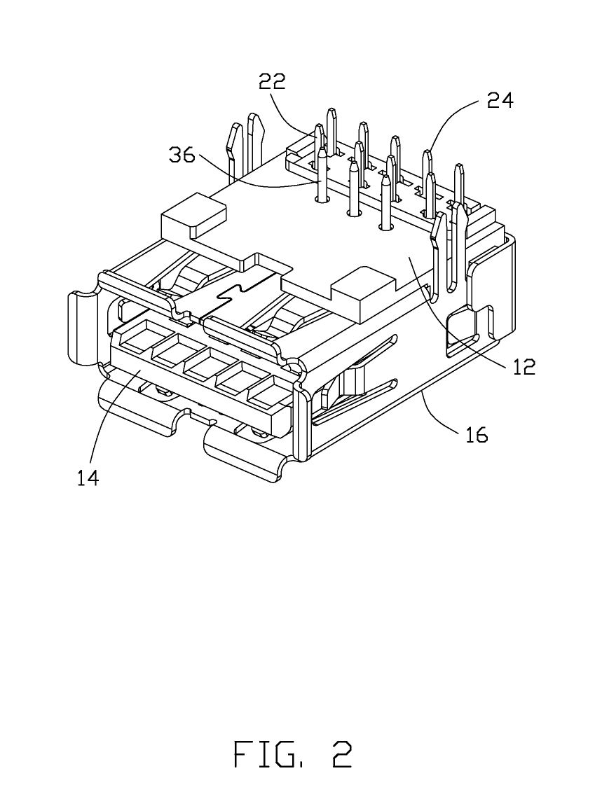

Referring to FIG. 2, the insulative housing 12 has a supporting plate outside the bottom wall of the metallic shell 16, which is shorter than the bottom wall so a front part of the bottom wall of the metallic shell 16 is exposed downwardly. The printed circuit board 26 together with the flexible member 34 thereon is attached to the bottom of the insulative housing 12 and the metallic shell 16, the flexible member 34 is located under the exposed front part of the bottom wall, the printed circuit board 26 upwardly abuts the supporting plate. The printed circuit board 26 has two gaps on two lateral sides thereof, the supporting plate has corresponding protrusions to engage with the gaps to position the printed circuit board 26. Finally, the flexible member 34 is vertically located under the spring tangs 20, and the button is vertically aligned with a portion of the corresponding spring tang 20 around a front portion of the mating cavity 18. And the front dome switch 30 of the printed circuit board 26 is disposed under the button to be activated by the button.

When the plug is inserted into the mating cavity 18, the spring tang 20 is outwardly deflected by the inserted plug to activate, via the flexible member 34, the front dome switch 30 and the corresponding detect pin 36 for verifying insertion of the plug. When the inserted plug requires the high power and is configured with a longer dimension of the mating portion in a front-to-back direction than the regular power one, the rear dome switch 32 will be activated to identify high power delivery while the regular power plug can not.

It should be noted that in the current embodiment, the housing is presented in a rough manner. In fact, the rear portion of the housing should remove a portion for communicating the rear dome switch with the corresponding spring tang of the shell. Understandably, alternatively in a simplified structure the dome switch with the associated flexible member may be directly activated by the inserted plug instead of through the spring tang. Furthermore, the flexible member tightly attached upon the printed circuit board around the dome switch in a sealed manner may prevent contamination of the dome switch advantageously. One feature of the invention is to provide a transition mechanism, i.e., the dome switch and the associated printed circuit board, between the detect pin and the inserted plug instead of direct confrontation between the inserted plug and the detect pin.

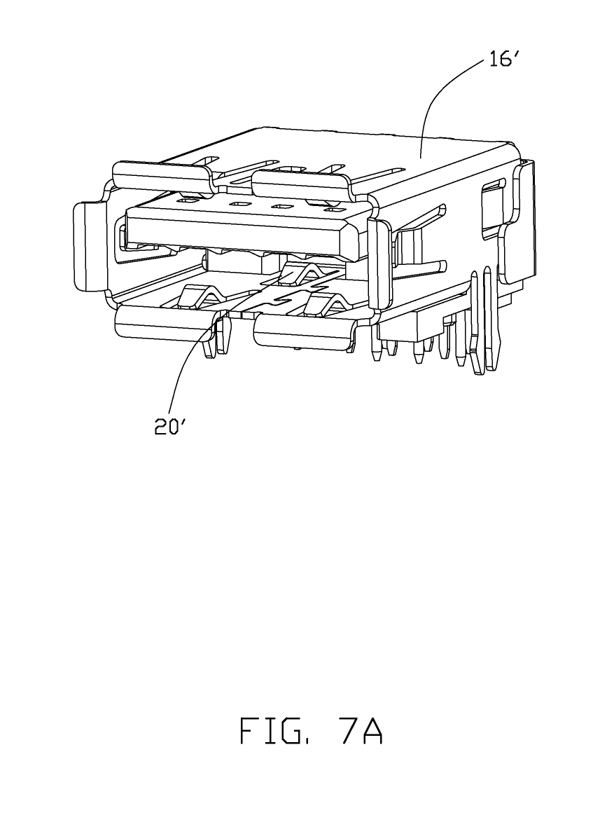

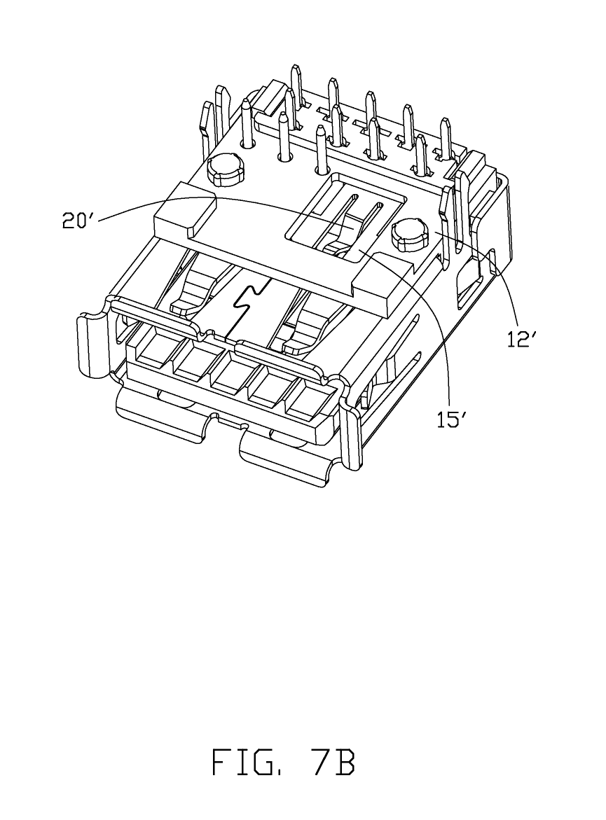

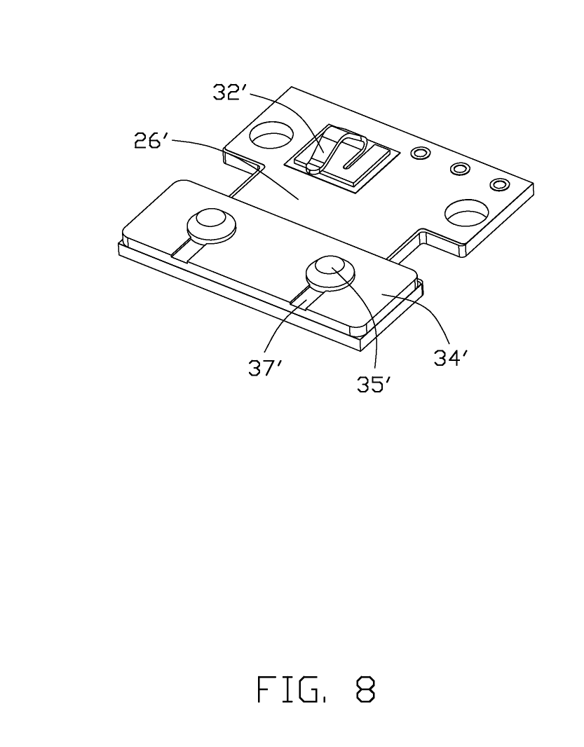

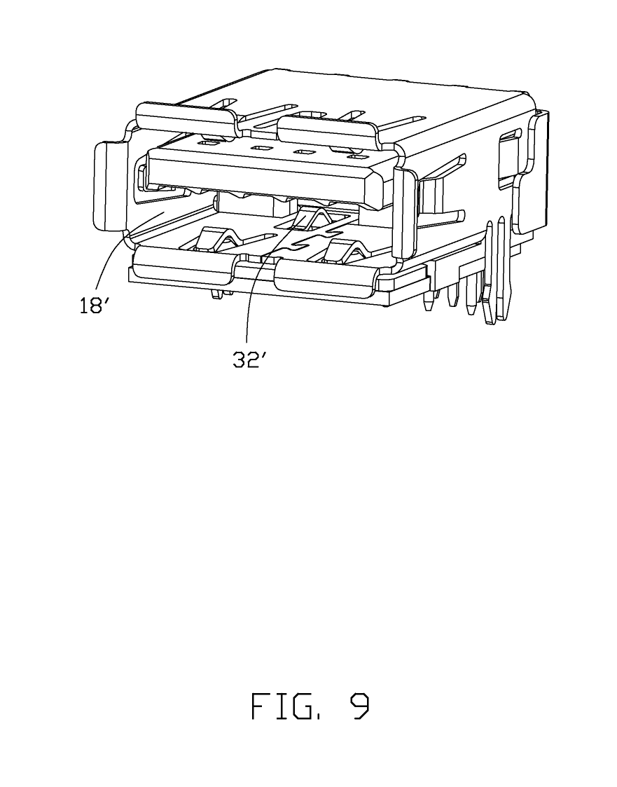

FIGS. 7A to 8 show the second embodiment of the instant invention, wherein the rear dome switch 32 in the first embodiment is replaced with the cantilevered contact 32′ mounted upon the printed circuit board 26′, the shell 16′ has a rear spring tang 20′, the insualtive housing 12′ correspondingly defines an opening 15′ for the rear spring tang 20′ directly actuating the cantilevered contact 32′. Furthermore, the flexible member 34′ has two buttons 35′, only one has a front dome switch (now shown) in below, but both buttons are depressed downwardly by the inserted plug so as to balance the force. The flexible member 34′ further has a plurality of slots 37′ in front of the buttons 35′ to receive front tips of the spring tang. The cantilevered contact 32′ electrically connects with the shell 16′ via a shell of the inserted plug, to form a conductive detection circuit. If the inserted plug is a Thin Card which has an insulative shell, the detection circuit will not be conductived. FIG. 9 shows another simple alternation of the second embodiment, the rear spring tang is canceled, and the cantilevered contact 32′ directly extends into the mating cavity 18′ for being directly activated by the inserted plug.

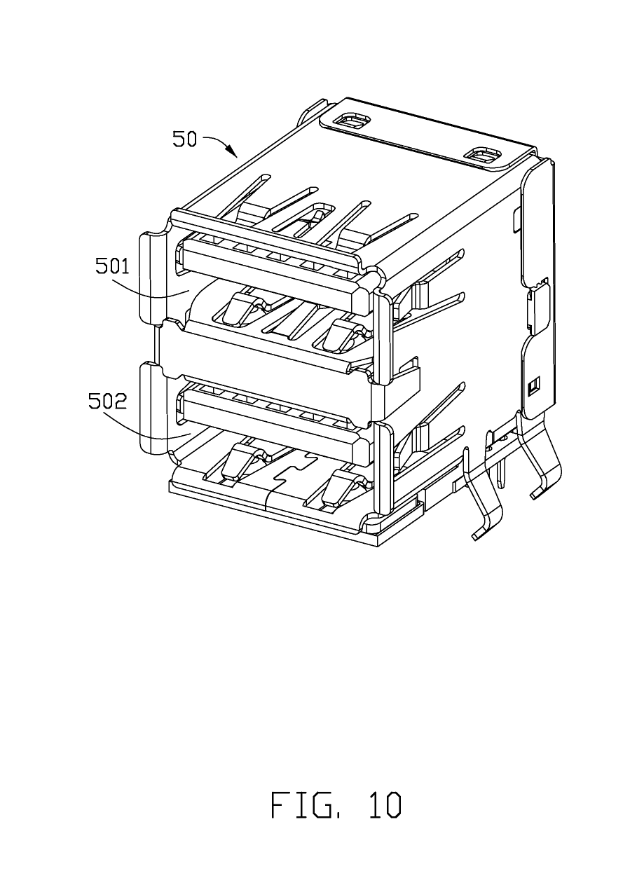

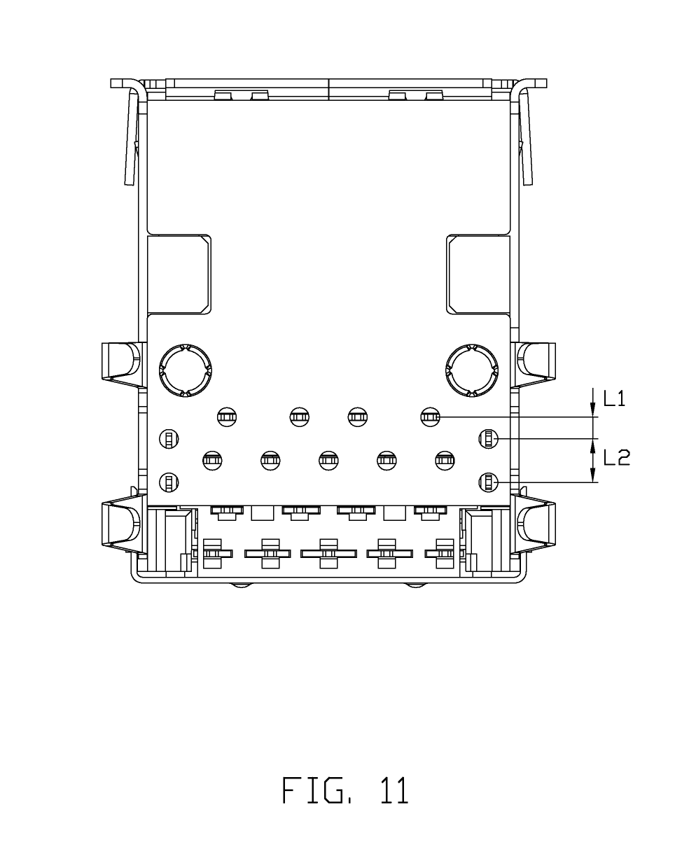

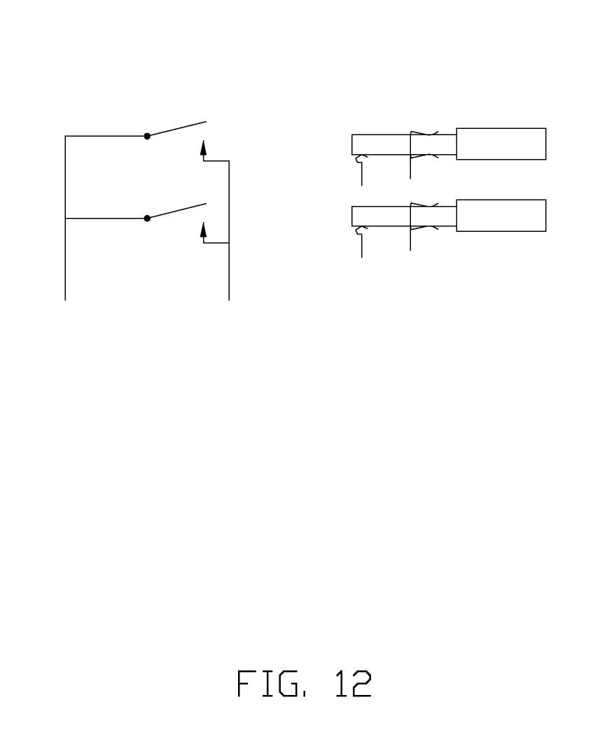

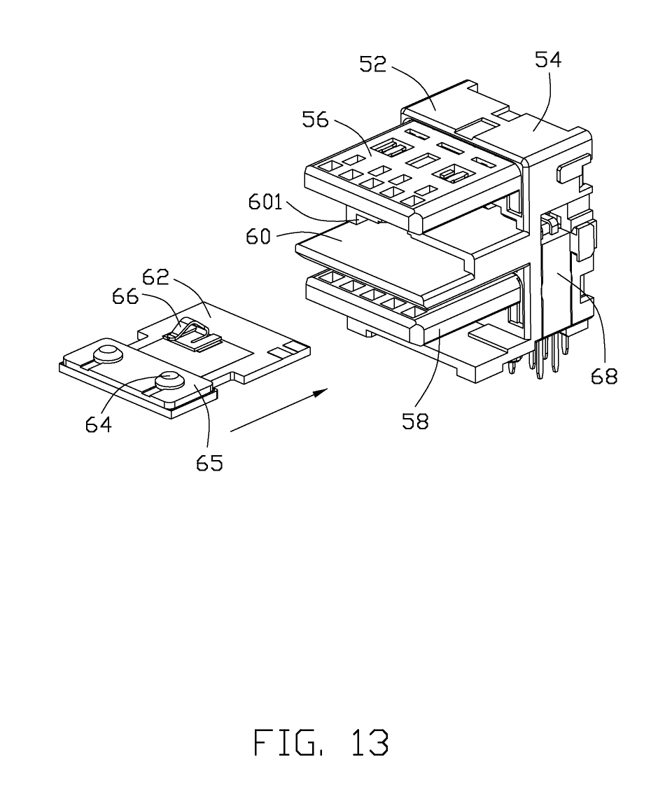

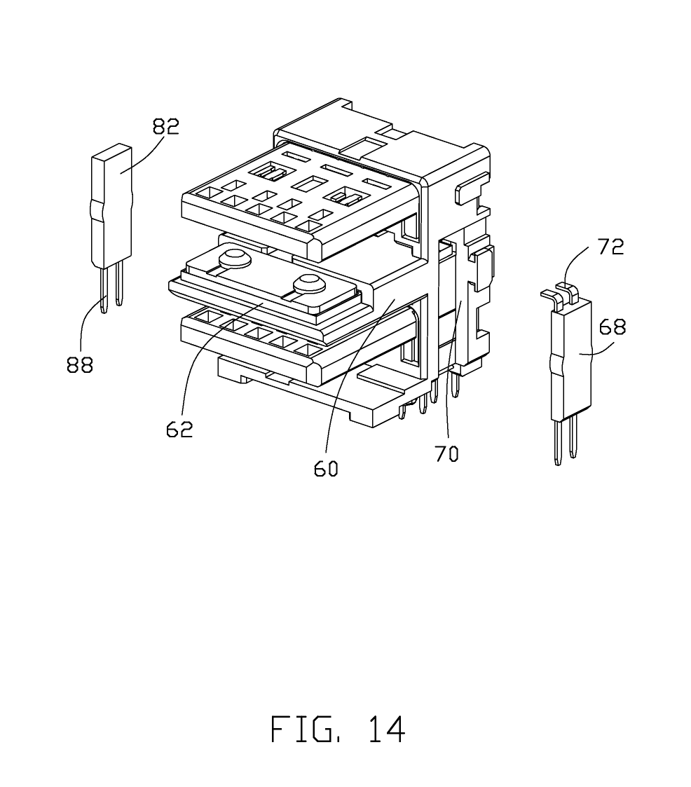

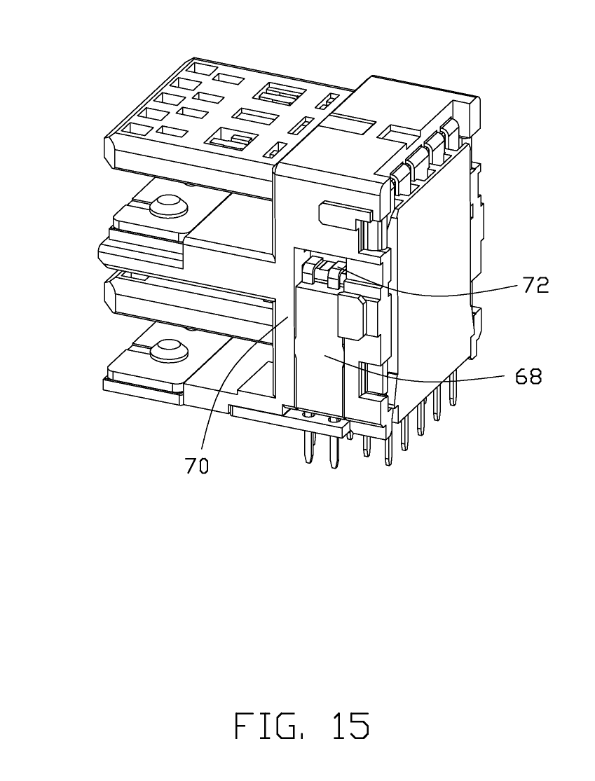

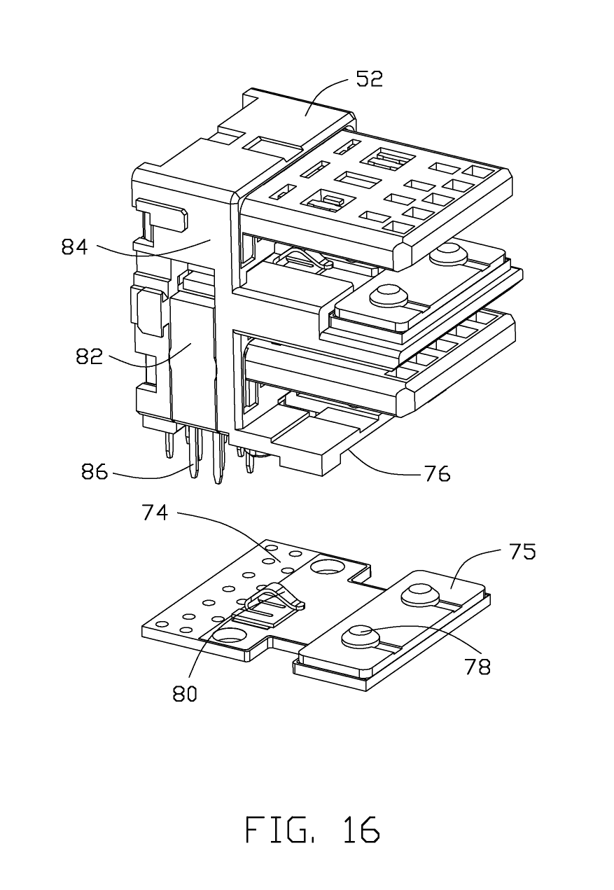

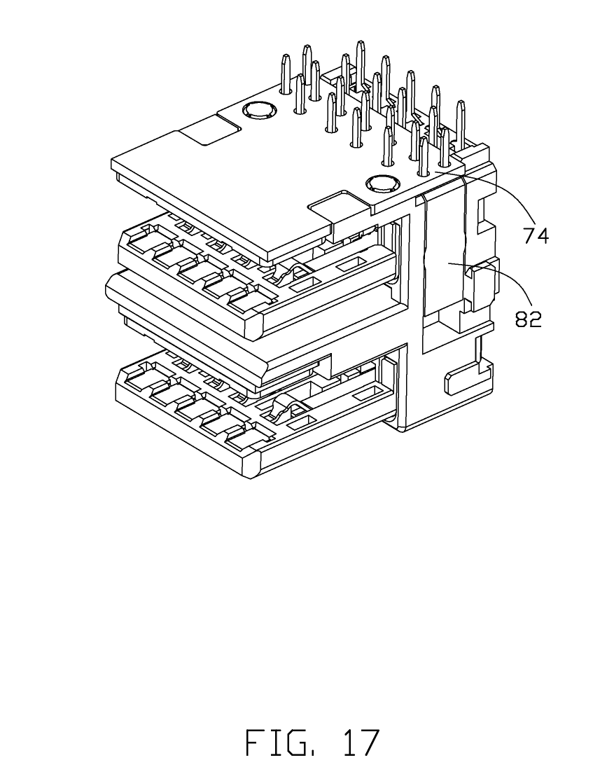

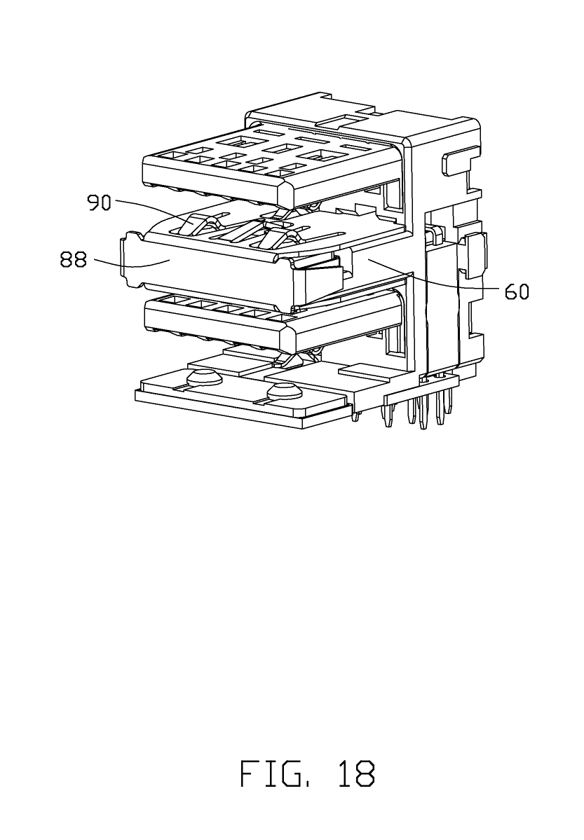

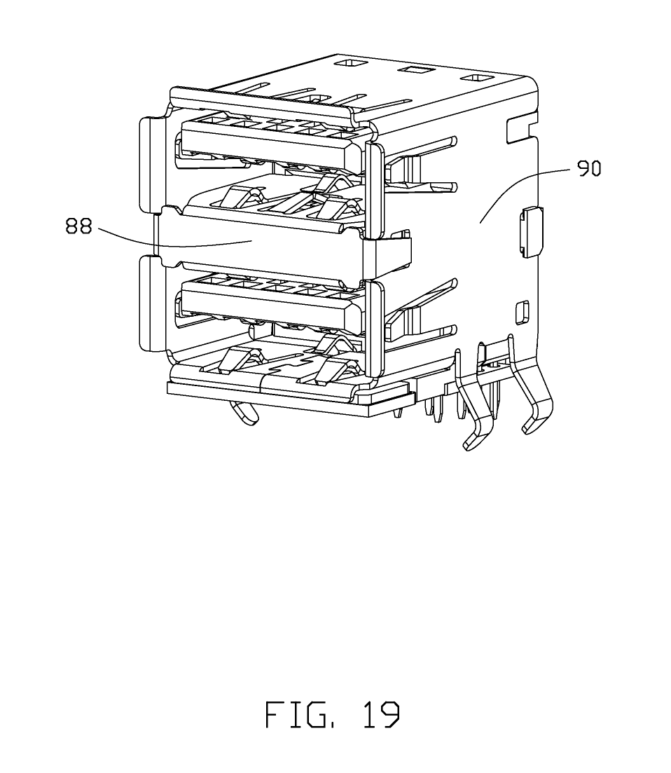

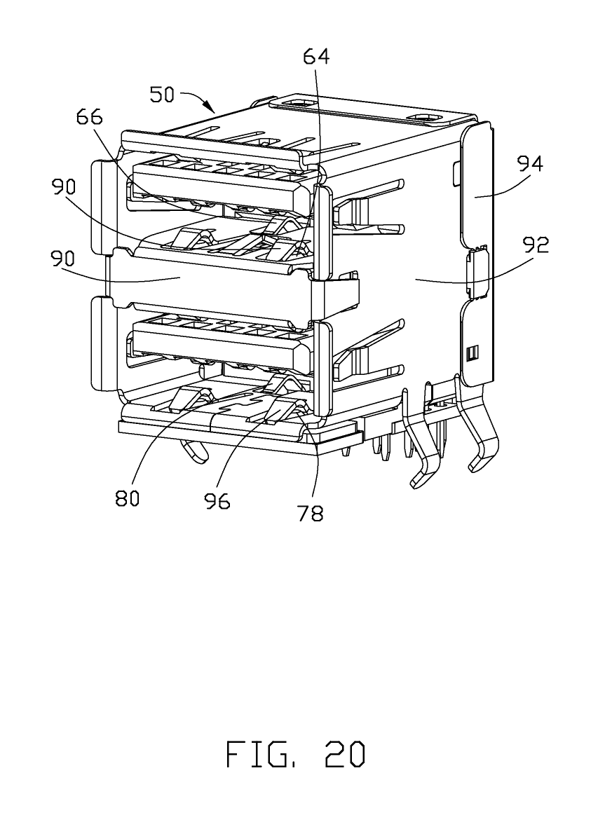

FIGS. 10-20 show the third embodiment of the instant invention wherein a dual port connector 50 includes an insulative housing 52 having a base 54 with an upper mating tongue 56 and a lower mating tongue 58 extending therefrom respectively into the upper mating port 501 and the lower mating portion 502 with a partition wall 60 therebetween in a vertical direction.

The partition wall 60 defines a room 601, an upper printed circuit board 62 is assembled rearwardly into the room 601 of partition wall 60 with thereon the front dome switch (not shown) for detecting insertion and the rear cantilevered contact 66 for power delivery detection. The front dome switch is covered by a flexible member 65 with buttons 64. A side PD pins insert molded assembly 68 for the upper port 501 is attached to a side wall 70 of the housing 52 with tops of corresponding detect pins 72 soldered upon the upper printed circuit board 62 and tails of the corresponding detect pins 72 extending outside for electrically connecting the front dome switch and cantilevered contact 66 to the mother board (not shown).

A lower printed circuit board 74 is assembled upwardly to a bottom wall 76 of the housing 52 by the way similar to that disclosed in the first and second embodiment with thereon the corresponding front dome switch (not shown) for insertion detection and rear cantilevered contact 80 for the power delivery detection. The front dome switch is covered by a flexible member 75 with buttons 78. Similar to the side PD pin insert molded assembly 68 for the upper port 501, another side PD pin insert molded assembly 82 is assembled to the other side wall 84 of the housing 52 with the corresponding detect pins 86 soldered upon the lower printed circuit board 74. Understandably, the detect pins 72 for the upper mating port 501 and the nine contacts of the lower mating port 502 also extend through the lower printed circuit board 74 for mechanical retention.

The dual port connector 50 has a shell completely covering the insulative housing, the shell has an center shell 88, a main shell 92 and a rear shell 94. The center shell 88 is assembled to the partition wall 60 and formed with the spring tangs 90, wherein the sprint tangs 90 extend into the upper mating port 501 and downwardly confronting the corresponding the button 64 for actuating the front dome switch below during mating with an inserted plug. The main shell 92 and a rear shell 94 are successively assembled to the housing for completing the whole connector 50. The main shell has a plurality of spring tangs 96 for pressing the button 78 to activate the front dome switch below.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for use with a plug comprising:
an insulative housing enclosed in a metallic shell to commonly define a mating port;
a plurality of contacts disposed in the housing with contacting sections exposed in the mating port;
a printed circuit board assembled to the bottom of the insulaitve housing and formed with at least a front dome switch and a rear switch, the front dome switch being moveable in a direction perpendicular to a front-to-back direction and adapted for being activated by the plug received in the mating port, the rear switch located at the rear of the mating port and adapted for being activated by the plug received in the mating port, the rear switch being a cantilevered contact; and
a plurality of detect pins electrically connected to the dome switch and the rear switch; wherein tails of the said contact and that of the detect pins are both arranged in a rear side of the housing.

2. The electrical connector as claimed in claim 1, wherein the shell defines a spring tang extending into the mating port and adapted to be outwardly deflected by the inserted plug to activate the front dome switch.

3. The electrical connector as claimed in claim 2, wherein the front dome switch is covered by a flexible member for anti-contamination, the flexible member has a button aligned with the front dome switch along a vertical direction and protruding upwardly so that the outwardly deflected spring tang can depress the button, then the button activates the front dome switch below.

4. The electrical connector as claimed in claim 3, wherein the flexible member has another button to balance the force when the plug is inserted.

5. The electrical connector as claimed in claim 4, wherein the flexible member has a slot in front of the button to receive a corresponding front tip of the spring tang.

6. The electrical connector as described in claim 1, wherein the insulative housing defines a through opening, the shell has a rear spring tang aligned with the cantilevered contact and protruding into the mating port via the opening, adapted for being actuated by the inserted plug to contact with the cantilevered contact.

7. The electrical connector as described in claim 5, wherein the cantilevered contact extends into the mating port for being directly actuated by the inserted plug.

8. The electrical connector as claimed in claim 1, wherein the detect pins are retained to the insulative housing and extend through the printed circuit board to electrically connect with the front dome switch and the cantilevered contact.

9. The electrical connector as described in claim 7, further comprising a PD pin insert molded assembly assembled to a side wall of the insulative housing, and having the detect pin therein.

10. A dual port connector comprising:
an insulative housing enclosed in a metallic shell to commonly define an upper mating port with an upper mating tongue therein and a lower mating port with a lower mating tongue therein;
a plurality of upper contacts disposed in the upper mating port;
a plurality of lower contacts disposed in the lower mating port;
an upper printed circuit board assembled between the upper mating port and the lower mating port and equipped with a front dome switch for insertion detection and a rear switch for power delivery detection; and
a lower printed circuit board assembled under a bottom wall of the housing with a front dome switch for insertion detection and a rear switch for power delivery detection.

11. The dual port connector as claimed in claim 10, further including a plurality of power delivery (PD) pins are soldered to each of the upper printed circuit board and the lower printed circuit board.

12. The dual port connector as claimed in claim 11, wherein said PD pins are unified within an insert molded assembly.

13. The dual port connector as claimed in claim 11, wherein the PD pins soldered to the upper printed circuit board and those soldered to the lower printed circuit board are respectively located on two opposite lateral sides of the housing.

14. The dual port connector as claimed in claim 10, wherein the rear switch is a dome switch.

15. The dual port connector as claimed in claim 10, wherein the shell is equipped with sprint tangs actuating the corresponding switches during mating with an inserted plug.

16. The dual port connector as claimed in claim 10, wherein the rear switch is a deflectable contact and extends into the mating port for being directly actuated by the inserted plug under a direct electrical connection with a metallic shell of said inserted plug while the front switch is covered by an insulative piece for not directly electrically connecting to the inserted plug.

17. The dual port connector as claimed in claim 10, wherein the housing includes a partition wall between the upper mating port and the lower mating port, and the upper printed circuit board is retained to the partition wall.

18. An electrical connector for use with a plug having a metallic shell, comprising:
an insulative housing defining a mating port, for receiving said plug, communicating with an exterior in a front-to-back direction and equipped with a mating tongue extending therein;
a plurality of contacts disposed in the housing with contacting sections exposed upon the mating tongue;
a first detect switch located around a front area of the mating port to identify whether the plug is inserted into the mating port; and
a second detect switch located around a rear area of the mating port to identify whether the plug having a longer mating dimension and requiring a larger power is inserted into the mating port; wherein
the front detect switch is shielded under an insulative member for not electrically connecting to the shell of the plug but mechanically actuated by the plug, while the rear detect switch is equipped with a metal piece to directly connect to the shell of the plug so as to differentiate the plug from an electronic card having a same mating interface with the plug.

19. The electrical connector as claimed in claim 18, further including a metallic shield enclosing the housing, wherein said first switch is actuated by a spring tang of the metallic shield which extends into the mating port for retaining the inserted plug in position.

20. The electrical connector as claimed in claim 19, further including a printed circuit board located under the metallic shield on which the first switch is located.
